(19) United States
(12) Patent Application Publication
(10) Pub. No.: US 2010/0237105 A1
(43) Pub. Date: Sep. 23, 2010

(54) Viscous Material Dispenser

(76) Inventor: John Zagone, Portland, OR (US)

Correspondence Address: HANCOCK HUGHEY LLP, P.O. BOX 1208, SISTERS, OR, 97759, US

(21) Appl. No.: 12/405,749

(22) Filed: Mar. 17, 2009

(51) Int. Cl. B67D 5/42; F16H 27/02

(52) U.S. Cl. 222/391; 74/141.5

(57) ABSTRACT

A material dispenser for receiving a material container and for dispensing material from the container is disclosed. The material dispenser includes a frame having a body, depending handle and an elongate cradle that extend forward from the body for retaining a material container. The material dispenser includes a trigger actuated plunger mechanism that is operative to push a piston in the material container to dispense material from the container. The material container is held in the material dispenser by a rear receptacle, a distal receptacle and is supported by the cradle. The dispenser includes a no-drool actuator lever that is operatively positioned forward of the trigger so that the operator may activate the actuator lever with the same hand that is being used to hold the dispenser. When the actuator lever is activated it relieves pressure on the plunger to thereby stop material from oozing unintentionally from the container.

### BACKGROUND

1. Field of the Invention

This invention pertains to the field of material dispensers that receive prepackaged containers of viscous material and provide a mechanical force to dispense the material from the container. Common viscous materials that are prepackaged and dispensed in this manner include latex and silicone caulk and construction adhesives.

2. Description of the Related Art

Caulk dispensers, also referred to as caulk, or caulking, guns, are disclosed in prior art patents U.S. Pat. Nos. 5,595,327, 5,553,754, and 2,801,775. Such dispensers receive a tube of caulk and provide a trigger-actuated plunger that pushes against a rear piston of the caulk tube to dispense caulk through a caulk tube nozzle.

Problematically, many prior art caulk dispensers drool caulk from the nozzle even after the dispenser operator stops actuating the plunger. Because the plunger is urged against the caulk tube piston (unless the plunger is disengaged), and because many viscous materials are compressible, caulk drools out of the nozzle even after the operator stops activating the plunger. This caulk drool can cause caulk to end up in unintended places and prevents a clean professional appearance to caulk work.

A partial work-around solution to caulk drool is to quickly disengage the plunger as soon as the operator desires to stop the flow of caulk. However, this solution requires quick two handed action—action which can be dangerous in some circumstances, such as when working on a ladder. Also, this solution does not address a problem of caulk drool while the operator temporarily ceases operation while re-cocking the dispenser trigger. Additionally, this solution is only a partial solution because many viscous materials, such as silicone caulk, are slightly compressed during the dispensing operation and continue to drool from the caulk tube even after the plunger is disengaged.

While it is normally advantageous to have a no-drool caulk dispenser, it is sometimes desirable to have a caulk dispenser that performs conventionally. Thus, a caulk dispenser that is easily convertible from no-drool operation to conventional operation is also desirable.

Another invention that addresses the problems associated with drooling caulk is disclosed in U.S. Pat. No. 6,155,463, which is assigned to the assignee of the present invention and which is incorporated herein by this reference. The caulk gun described in the '463 patent incorporates a no-drool feature that is defined by a dog that is located immediately rearward of the handle that a user grasps when using the gun. In practice it has been found that in order to actuate the no-drool feature the user either has to use two hands, which can be dangerous in some situations such as when the user is on a ladder, or must reposition the caulk gun, which often results in inaccurate work.

There is a need therefore for a material dispenser that incorporates a no-drool feature that is simple to operate.

The present invention is defined by a material dispenser that includes a no-drool mechanism that may be actuated easily and quickly. The actuator lever that activates the no-drool mechanism is located forwardly of the handle that is squeezed to deliver material from the dispenser and the lever is easily operated with one hand.

### BRIEF DESCRIPTION OF THE DRAWINGS

FIG. 1 is a side elevation and partially cut away view of a material dispenser according to the prior art, having a material container mounted therein, and illustrating a no-drool actuation lever according to the prior art.

FIG. 2 is side elevation, partially cut away and partially sectional view of a first illustrated embodiment of a material dispenser according to the present invention with the actuation lever for the no-drool feature located forward of the trigger.

FIG. 3 is side elevation, partially cut away and partially sectional view of a second illustrated embodiment of a material dispenser according to the present invention with the actuation lever for the no-drool feature located forward of the trigger.

FIG. 4 is side elevation, partially cut away and partially sectional view of a third illustrated embodiment of a material dispenser according to the present invention with the actuation lever for the no-drool feature located forward of the trigger and illustrating the actuation lever in a first position that is used to dispense material from the material container.

FIG. 5 is side elevation, partially cut away and partially sectional view of the material dispenser shown in FIG. 4, but illustrating the actuation lever in a second position that is used to stop material from drooling out of the container nozzle.

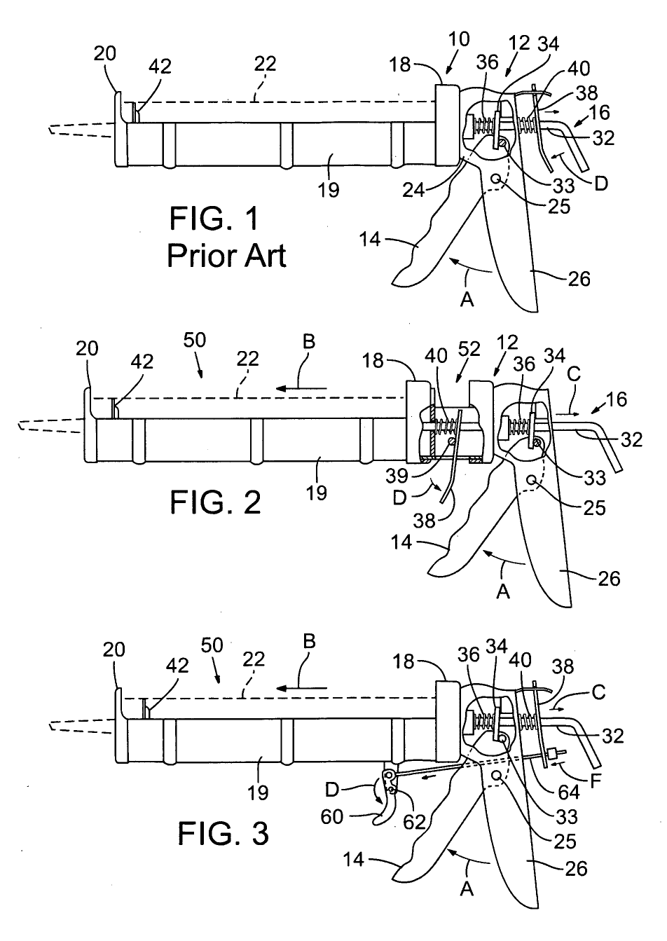

### DESCRIPTION OF THE PRIOR ART AS SHOWN IN FIG. 1

As noted previously, a material dispenser 10 according to the prior art is shown in FIG. 1. The material dispenser includes an elongate frame 12, onto which are mounted a trigger 14, a plunger mechanism 16, a rear receptacle 18, and a distal receptacle 20. As used herein, the term “forward” refers to the direction toward distal receptacle 20 (also referred to as the forward receptacle 20) from trigger 14, and the relative term “rearward” refers to the opposite direction. A semi-circular elongate tray member 19 is attached to rear receptacle 18 and distal receptacle 20 and defines a cradle for holding a material container such as material container 22, which is shown in dashed lines mounted in tray member 19 in the material dispenser 10 and retained therein by rear receptacle 18 and distal receptacle 20. The frame 12 includes a main body 24 with a depending handle 26. The trigger 14 is pivotally coupled to the frame body 24 at a location near the demarcation between the body 24 and handle 26. Trigger 14 is pivotally attached to the handle by a pivot shaft 25.

The plunger mechanism 16 includes a plunger rod 32, a first dog 34, first spring 36, second dog 38, second spring 40, and push plate 42 attached to the distal end of plunger rod 32. As shown in the figures, the plunger rod extends through bores in both of the first and second dogs, and the plunger rod extends through the first and second springs. Importantly, second dog 38, which is the dog that defines the actuating lever for the no-drool feature of the dispenser 10, is located rearward of the handle 26 and trigger 14. In operation, the no-drool feature is activated by pushing dog 38 in the direction of arrow D in FIG. 1. This operation may sometimes be accomplished with the user's thumb, but often two hands are required to activate the no-drool feature.

A material container 22 is mounted in the cradle defined by tray member 19 by inserting a rear end of the container into the rear receptacle 18 at an angle and pushing the tube fully into the rear receptacle and then swinging the caulk tube downward into the tray 19 while the tube nozzle is guided into a nozzle cutout in the distal—i.e., forward, receptacle 20. The material container is then slid forward to rest against an inside surface of the forward receptacle 20. When the push plate 42 on the distal end of plunger rod 32 pushes against the internal piston of the material container, the material container is pushed forward until it abuts the forward receptacle 20. This prevents further forward motion of the material container.

To accommodate mounting the caulk tube into the cradle, the distance between the rear receptacle and the forward receptacle is greater than the length of the caulk tube.

### DETAILED DESCRIPTION OF THE ILLUSTRATED EMBODIMENTS

The invention is defined by the material dispensers 10 illustrated in the embodiments of FIGS. 2 through 5. In each of these figures, structures that are either identical or analogous to, both structure and function, those described previously with respect to the prior art of FIG. 1 are identified with the same reference numbers. Thus, with reference to FIG. 2, a material dispenser 50 according to the present invention includes an elongate frame 12, onto which are mounted a trigger 14, a plunger mechanism 16, a rear receptacle 18, and a distal receptacle 20. Again, the term “forward” refers to the direction toward distal receptacle 20 from trigger 14, and the term “rearward” refers to the opposite direction. A semi-circular elongate tray member 19 is attached to rear receptacle 18 and distal receptacle 20 and defines a cradle for holding a material container such as material container 22, which is shown in dashed lines mounted in tray member 19 in the material dispenser 10 and retained by rear receptacle 18 and distal receptacle 20. The frame 12 includes a main body 24 with a depending handle 26. The trigger 14 is pivotally coupled to the frame body 24 at a location near the junction between the body 24 and handle 26. Trigger 14 is pivotally attached to the handle by a pivot shaft 25. The style of a material dispenser 10 shown in FIG. 2 that utilizes a semi-circular tray 19 is sometimes referred to as a “half barrel” model. It will be understood that the invention described herein will work just as well with a “dual rail” or “parallel frame” style of material dispenser as shown in the '463 patent, referenced above.

The plunger mechanism 16 includes a plunger rod 32, a first dog 34, first spring 36, second dog 38, second spring 40, and push plate 42 attached to the distal end of plunger rod 32. As shown in the figures, the plunger rod extends through bores in both of the first and second dogs, and the plunger rod extends through the first and second springs.

Importantly, and distinguishable from the prior art of FIG. 1, the second dog 38 in each of the embodiments of FIGS. 2, 3, 4 and 5, which is the dog that defines the actuating lever for the no-drool feature of the dispenser 50, is located forward of the handle 26 and trigger 14.

A drive pin 33 is positioned on trigger 14 so that the drive pin is rearward of first dog 34 and below plunger rod 32. The body 24 of material dispenser 50 shown in FIGS. 2, 4 and 5 includes an extended section 52 located immediately rearward of rear receptacle 18. The extended section 52 defines a space forward of trigger 14 through which plunger rod 32 extends, and which accommodates second dog 38 so that the second dog is located in a position that the no-drool activation lever—second dog 38—is easily accessed by the user.

The “resting” or normal position of trigger 14 relative to handle 26 is shown in FIG. 2. In this position, drive pin 33 is being driven rearwardly by the force of first spring 36 acting on first dog 34. This causes trigger 14 to be driven into its resting position by pivoting about pivot shaft 25 (arrow A). A material container 22 is inserted into the dispenser 10 in the conventional manner, with distal push plate 42 received into the rearward end of the container.

The trigger 14 is operated by manually squeezing the trigger and handle 26 to force the trigger to pivot backward about pivot shaft 25, moving the trigger toward the handle (i.e., in the direction opposite arrow A). This backward motion of the trigger 14 causes drive pin 33 to push against a lower portion of the first dog 34, moving the dog forwardly and canting it on the plunger rod 32 so that the first dog engages the plunger rod and forces it forward in the direction of arrow B in FIG. 2. When pressure on the trigger is relaxed, the first spring 36 urges the first dog 34 backward in the direction of arrow C and pivots the trigger 14 forwardly to its resting position. Absent other forces on the plunger mechanism 16, the plunger rod 32 will move backward in the direction of arrow C as the backward pressure on the trigger is relaxed because the first dog is canted on the plunger rod until it reaches a resting position against the frame body 24 as shown in FIG. 2.

The dispensers of FIGS. 2, 3, 4 and 5 have two modes of operation, depending on the position of the second dog 38. When the second dog is in a resting position, as shown in FIG. 2, the second spring 40 biases the second dog rearward canting the second dog on a pin 39 that is located below the plunger rod 32 and which has its ends fixed to the body. The second dog engages the plunger rod 32 and prevents backward motion of the plunger rod 32 in the direction of arrow C, while at the same time permitting forward motion of the rod 32 in the direction of arrow B when the trigger 14 is squeezed. This mode is designated the conventional mode.

In the conventional mode, operation of the trigger cants the first dog 34 on the plunger rod so that the first dog engages the plunger rod and moves the plunger rod forward in the direction of arrow B. Releasing pressure on the trigger 14 allows the first spring 36 to urge the first dog backward. Because the first dog is still canted on the plunger rod, the plunger rod is urged backward too. However, backward motion of the plunger rod is prevented by the second dog and the first dog skids backward along the plunger rod without effect. Thus, in the conventional mode, the plunger rod can proceed only forward in the direction of arrow B. To move the plunger rod backward in the direction of arrow C, the second dog must be actuated.

A second mode is achieved by actuating the second dog 38 as shown in FIG. 2 with arrow D. This is done by the operator using a finger to grasp the second dog, which is positioned just forward of the trigger 14, and pulling the second dog 38 rearward toward the handle (arrow D). This activates the no-drool or second mode. In this mode the second dog 38 is not canted on, and does not engage, the plunger rod 32. Movement of the plunger rod 32 is not affected by the second dog when the second dog is actuated as described.

In this second mode, designated the no-drool mode, the plunger rod 32 is urged rearwardly in the direction of arrow C because forward pressure caused by the action of trigger 14 and first dog 34 has been released. The release of pressure on push plate 42 stops any material from drooling out the nozzle on the material container 22. If trigger 14 is squeezed while second dog is in the actuated, or no-drool position, the trigger 14 cants the first dog on the plunger rod 32 and moves the plunger rod forward in the direction of arrow B. However, when pressure on the trigger is relaxed, the first spring 36 moves the first dog 34 backward and likewise urges the plunger rod 32 backward in the direction of arrow C.

Importantly, because second dog 38 is located forwardly relative to trigger 14, an operator may actuate the no-drool function with the same hand that is being used to squeeze the trigger 14. This results in a significantly safer way to use the material dispenser, especially when the user is on a ladder or on a roof.

It will be appreciated that there are numerous structural mechanisms that may be used to operationally locate the actuation lever for second dog 38—i.e., the no-drool dog—forward of the trigger 14. One alternative embodiment is illustrated in FIG. 3, where a separate trigger 60 is attached to the lower side tray 19 forward of handle 14 to actuate second dog 38, which in this embodiment is positioned rearward of handle 26. The trigger 60 pivots about a pivot shaft 62, and a rod 64 has one end attached to the trigger 60 above pivot shaft 62. The rod 64 extends through trigger 14 and handle 26 and has its opposite end attached to second dog 38. Spring 40 maintains trigger 60 in a normal resting position, shown in FIG. 3. When the trigger 60 is pivoted by the operator in the direction of arrow D, rod 64 moves in the direction of arrow F and thus causes the dispenser 50 to move into the no-drool mode described above by moving second dog 38 to the position where the dog does not engage plunder rod 32.

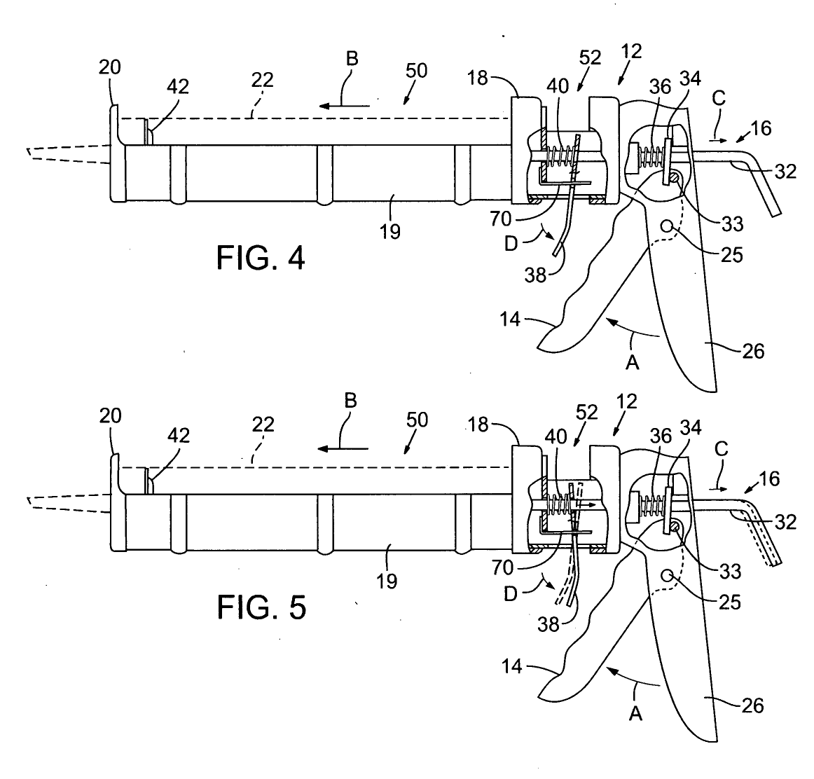

Yet another equivalent mechanism for actuating the no-drool function is illustrated in FIGS. 4 and 5. In this embodiment, in which second dog 38 is located forward of handle 14, pin 39 has been replaced by a bracket 70 that retains the second dog 38 in position relative to frame 12 and plunger rod 32. The resting position of second dog 38 is shown in FIG. 4 and the actuated position of second dog 38 is shown in FIG. 5.

When the second dog 38 is in a resting position, as shown in FIG. 4, the second spring 40 biases the second dog rearward canting the second dog on bracket 70 so that the second dog grabs the plunger rod 32 and prevents backward motion of the plunger rod 32 in the direction of arrow C, while at the same time permitting forward motion of the rod 32 in the direction of arrow B when the trigger 14 is squeezed. As described above, this mode is the conventional mode. In the conventional mode, operation of the trigger cants the first dog 34 on the plunger rod so that the first dog 34 grabs the plunger rod and moves the plunger rod forward in the direction of arrow B. Releasing pressure on the trigger 14 allows the first spring 36 to urge the first dog backward. Because the first dog is still canted on the plunger rod, the plunger rod is urged backward too. However, backward motion of the plunger rod is prevented by the second dog and the first dog skids backward along the plunger rod without effect. Thus, in the conventional mode, the plunger rod can proceed only forward in the direction of arrow B. To move the plunger rod backward in the direction of arrow C, the second dog must be operated.

The second mode, or no-drool mode, is achieved by actuating the second dog 38 as shown in FIG. 5 with arrow D, moving the second dog from its resting position shown in solid lines, to the activated position shown in dashed lines. This is done by the operator using a finger to grab the second dog, which is positioned just forward of the trigger 14, and pulling the second dog 38 rearward toward the handle (arrow D). This activates the no-drool function. In this mode the second dog 38 is not canted on, and does not grip, the plunger rod 32. Movement of the plunger rod 32 is not affected by the second dog when the second dog is actuated as described.

In the second mode, the plunger rod 32 is urged rearwardly in the direction of arrow C because forward pressure caused by the action of trigger 14 and first dog 34 has been released. The release of pressure on push plate 42 stops any material from drooling out the nozzle on the material container 22. If trigger 14 is squeezed while second dog is in the actuated, or no-drool position, the trigger 14 cants the first dog on the plunger rod 32 and moves the plunger rod forward in the direction of arrow B. However, when pressure on the trigger is relaxed, the first spring 36 moves the first dog 34 backward and likewise urges the plunger rod 32 backward in the direction of arrow C. In addition, when the second dog is actuated the plunger rod 32 may be pulled backwardly in order to withdraw the plunger and push plate from the caulk tube, and to thereby remove the caulk tube from the dispenser.

While substantial discussion, particularly in the background and summary of the invention, describes the dispenser as a dispenser for caulk that is provided in cylindrical tubes, the invention is also applicable to other applications that dispense a viscous material from a container wherein the container includes a moveable surface that can be forced to move to expel the material from the container. Thus, for example, the dispenser may be used to dispense adhesives, tars, viscous plastics, viscous cementious derivatives, or any other such material.

Further, the dispenser may be used to dispense such material from containers other than cylindrical, elongate tubes, such as square cross-section tubes, oval cross-section tubes, short tubes (i.e., not elongate), and cubes. Any container having a substantially uniform cross-section along its length may be used with the present invention and would require only that the dispenser described above and shown in the accompanying drawings be modified to be compatible with the cross section such as by modifying the plunger and container receptacles.

The present invention defines a material dispenser that is operable in a no-drool mode and wherein the trigger that actuates the no-drool feature is positioned forward of the trigger and handle. This makes for a much safer design than prior designs since the operator may activate the no-drool mode with the same hand that is being used to squeeze the trigger. From the foregoing detailed description it will be apparent that there are many different structures that are equivalent to the various embodiments described herein that will allow the actuator to be moved forward of the caulk gun trigger. Although the specification describes preferred embodiments, the claims are not limited by the specific structures described herein but are instead intended to extend to the full scope permitted by law.

This specification sets forth the best mode for carrying out the invention as known at the time of filing the patent application and provides sufficient information to enable a person skilled in the art to make and use the invention. The specification further describes materials, shapes, configurations and arrangements of parts for making and using the invention. However, it is intended that the scope of the invention shall be limited by the language of the claims as construed by the law of the land as pertains to valid U.S. patents.

What is claimed is:

1. A material dispensing apparatus, comprising:
an elongate frame adapted to retain a removable material container, said frame defining a forward end and a rearward end;
a handle attached to the body;
a first trigger hingedly connected to the handle;
an elongate plunger slidably connected in the body;
a first dog actuated by said trigger to engage said plunger and to drive it longitudinally relative to said tube of viscous material in a first direction;
a second dog which in a first position engages said plunger to prevent said plunger from moving longitudinally relative to said material container in a second direction that is opposite said first direction, and which in a second position releases said plunger to allow said plunder to move in said second direction, said second dog operationally located forward of said trigger.

2. The apparatus of claim 1 wherein said frame includes a first receptacle for retaining the material container at a forward end of the frame, and a second receptacle for retaining the material container at a rearward end of the frame, said frame further including an opening rearward of said second receptacle through which said elongate plunger extends and wherein said second dog is located in said opening.

3. The apparatus of claim 1 wherein said second dog is located rearwardly of said handle, and including a second trigger positioned forward of said first trigger and operatively connected to said second dog so that operation of said second trigger from a first position to a second position causes movement of said second dog from said first position to said second position.

4. The apparatus of claim 2 including a spring for normally biasing said second dog into said first position.

5. The apparatus of claim 1 wherein said plunger extends through an opening in the first dog and the second dog.

6. The apparatus of claim 1 including a spring for biasing said first trigger into a normally relaxed first position.

7. The apparatus of claim 6 wherein movement of said first trigger in a first direction from said normally relaxed first position to a second position cants said first dog on said plunger such that said dog engages said plunger to drive it in said first direction.

8. The apparatus of claim 7 wherein when in the first position said second dog is canted relative to said plunger such that said plunger is movable in the first direction but resists movement in the second direction.

9. A material dispenser, comprising:
an elongate body adapted to retain a removable tube of viscous material between a first receptacle at a forward end of the body and a second receptacle at a rearward end of the body;
a first trigger operatively connected to an elongate plunger slidably held in the body so that operation of the trigger moves the plunger longitudinally relative to the body;
plunger engagement means for moving said plunger in a first direction when said trigger is operated; and
plunger disengagement means located forward of said trigger and for selectively engaging said plunger to prevent movement of said plunger in the direction axially opposite said first direction and for disengaging said plunger to permit movement of said plunger in the direction axially opposite said first direction.

10. The material dispenser of claim 9 wherein the plunger disengagement means further comprises a dog through which said plunger extends, and wherein said dog is located forward of said trigger.

11. The material dispenser of claim 9 wherein the plunger disengagement means further comprises a dog through which said plunger extends, and wherein said dog is located rearward of said trigger.

12. The material dispenser of claim 11 including a second trigger located forward of said first trigger and operatively connected to said dog so that movement of said second trigger from a first position to a second position moves said dog from a first position to a second position.

13. The material dispenser of claim 10 wherein said plunger disengagement means comprises a dog having a passageway through which said plunger extends and which is selectively movable between a first position in which said dog is canted relative to said plunger and engages said plunger thereby allowing movement of the plunger in the first direction but resisting movement of the plunger in the direction axially opposite the first direction, and a second position in which said plunger allows for movement of said plunger through said passageway in either the first or second directions.

14. In an apparatus for dispensing viscous material of the type having an elongate body adapted to retain a removable tube of the viscous material, a handle attached to the body and a trigger pivotally connected thereto so that operation of the trigger moves an elongate plunger slidably held in the body and operatively connected to the trigger longitudinally forward relative to the body to expel the viscous material, and operation of the trigger away from the handle urges the plunger longitudinally rearward relative to the body, the improvement comprising:
a dog movable between a first position in which said dog prevents said plunger from moving longitudinally rearward relative to the body when the trigger is moved away from said handle, and a second position in which said plunger is movable in said rearward direction when the trigger is moved away from said handle, said dog actuated from a position forward of said trigger.

15. The apparatus of claim 14 including means for biasing said dog into said first position.

16. The actuator of claim 15 wherein said biasing means comprises a spring.
